(19) United States
(12) Patent Application Publication
(10) Pub. No.: US 2024/0291384 A1
(43) Pub. Date: Aug. 29, 2024

(54) INDUCTOR-LESS POWER CONVERTER

(71) Applicant: NEXPERIA B.V, Nijmegen (NL)

(72) Inventor: Joram Pieter VAN DER VELDEN, Delft (NL)

(73) Assignee: NEXPERIA B.V., Nijmegen (NL)

(21) Appl. No.: 18/659,162

(22) Filed: May 9, 2024

Related U.S. Application Data
(63) Continuation of application No. PCT/NL2022/050630, filed on Nov. 8, 2022.

(30) Foreign Application Priority Data
Nov. 9, 2021 (NL) 2029699
Apr. 21, 2022 (NL) 2031652

(51) Int. Cl. H02M 3/07; H02J 50/00; H02M 1/00

(52) U.S. Cl. CPC H02M 3/07; H02J 50/001; H02M 1/0083; H02J 2300/26

(57) ABSTRACT

An inductor-less power converter for converting an input voltage to an output voltage at a conversion ratio is provided, including a plurality of stages, each stage has a capacitor, switching means and a node, the capacitor being configured as a switched capacitor, the switching means for switching the stage and connecting the capacitor, and the node for connecting one of an input voltage, output voltage or ground to the node, and the inductor-less power converter is a reconfigurable power converter including at least four stages, each of the stage includes an input voltage node, an output voltage node and a ground node, and the switching means are arranged for connecting the respective stage to one of the input voltage node, output voltage node and ground node for obtaining a plurality of different configurations, providing a plurality of different conversion ratios for converting the input voltage to the output voltage.

### CROSS-REFERENCE TO RELATED APPLICATIONS

This application is a continuation of International Application No. PCT/NL2022/050630, filed on Nov. 8, 2022, which claims priority to both Netherlands Patent Application No. 2031652, filed on Apr. 21, 2022, and to Netherlands Patent Application No. 2029699, filed on Nov. 9, 2021, the contents of all applications are incorporated by reference herein in their entirety.

### BACKGROUND

### 1. Field of the Disclosure

Power converters are electric devices for converting an input voltage to an output voltage. These voltages may differ according to a conversion ratio and the input current may differ in form and/or frequency from the output current, e.g. the converter may be arranged to convert an Alternating Current, AC, input voltage to a Direct Current, DC, output voltage, preferably of a different voltage differential.

### 2. Description of the Related Art

Such power converters for converting the electrical energy from one voltage level to another, or from one frequency to another, or from one type into another, are typically used in portable electronic devices such a cellular phone, laptop computer, portable computers, but are also widely used in Internet-of-Things, IoT, devices or Wireless Sensor Nodes, WSNs. In such applications the main power supply often (primarily) comes from a battery and often these devices further have an energy harvesting module to harvest energy to charge the battery and/or power the load.

Power converters designed around a series of switches and capacitors are well known and widely used. Recently switched capacitor designs with several stages are becoming increasingly popular. Such designs have advantages over known inductor based power converters as there are no magnetic or large formfactor components, which makes them suitable for small integrational designs or even fully integrated implementations.

Also, such designs do not require dummy loads and are usable in a wider range of loads. Also, the conversion efficiency of these power converters is typically higher than those of inductor based alternatives. All in all such inductor-less designs are typically ideal for battery-operated applications.

Inductor-less designs however also have drawbacks as compared to the inductor based alternatives, as inductor based power converters have large to a continue conversion ratios, whereas inductor-less designs have a limited discrete number of conversion ratios and low maximum and/or minimum conversion ratio.

There is therefore a need for an improved inductor-less power converter. And it is an object of the present disclosure to provide for such an improved inductor-less power converter in which at least some of the above mentioned drawbacks have been resolved.

It is a further object of the present disclosure to provide for an improved inductor-less power converter having a higher number of conversion ratios, higher maximum and minimum conversion ratio, and suitable for fully integrated implementation of the design.

### SUMMARY

In a first aspect there is provided an inductor-less power converter for converting an input voltage to an output voltage at a conversion ratio, comprising a plurality of stages, each stage comprising a capacitor, switching means and a node, said capacitor being configured as a switched capacitor, said switching means being arranged for switching said stage and connecting said capacitor, and said node being arranged for connecting one of an input voltage, output voltage or ground to said node, wherein said inductor-less power converter is a reconfigurable power converter comprising at least four stages, wherein each of said stage comprises an input voltage node, an output voltage node and a ground node, and wherein said switching means are arranged for connecting said respective stage to one of said input voltage node, output voltage node and ground node for obtaining a plurality of different configurations, providing a plurality of different conversion ratios for converting said input voltage to said output voltage.

The proposed (k−1)-phase power converter has several advantages over known power converters as it provides a higher maximum conversion ratio of 16, a better minimum conversion ratio of 1/16, and more in general a maximum or minimum conversion ratio of 2\hat{ }(k−2). Therefore the input voltage can be a factor 2\hat{ }(k−2) or in said particular example 16 larger or smaller than the output voltage.

Although the design of the control is more complex, the proposed design provides more discrete conversion ratios which can be attained easily, and which in turn allows better matching of the input and output voltage. The design further enables a fully integrated implementation.

What is proposed is a preferably 5-phase, Binary Switching Capacitor, SC, converter using 4 flying capacitors. The number of flying capacitors and phases is increased in comparison to known designs to achieve a higher maximum conversion ratio of 16. Many different voltage conversion ratios can be attained rather easily by controlling 6 sets of switches, connecting 6 nodes of the SC Converter to either the ground, input or output node. In the configuration of 6 sets of switches, 729 (3\hat{ }6) different configurations can be made with these connections, of which 178 unique voltage conversion ratios are obtained, of which 119 are positive.

Both step-up and step-down conversions are possible and the maximum and minimum attainable positive voltage conversion ratio are M=16 and M=1/16 respectively.

Additionally, instead of using typical SPTT switches, this design features only SPST (Single-Pole-Single-Throw) switches are proposed, which makes it suitable for a design in CMOS technology.

Inductor-less power converters always operate with a limited number of voltage conversion ratios, contrary to inductor-based power converters which can theoretically achieve any conversion ratio.

The proposed inductor-less SC converter is better able to match any arbitrary input and output voltage within the conversion range, due to the wide range and large number of conversion ratios. Generally, this can result in a higher conversion efficiency and lower voltage ripple at the input or output. In the area of energy harvesting, this can increase the ability to match the input voltage of the power converter to the maximum power point (MPP) voltage of a harvester, if applicable.

In an example, said switching means of each of said stages comprise a single-pole-single-throw switch for connecting said respective stage to one of said input voltage node, output voltage node and ground node.

In an example, the converter further comprises a pre-stage and an post-stage, each of said pre-stage and post-stage preferably comprising switching means for connecting one of an input voltage node, output voltage node and ground node.

In an example, the converter further comprises a controller for controlling said switching means of each of said stages, wherein said controller is arranged for at least (k−1) phases.

In an example, said power converter is arranged for bi-directional power conversion.

In an example, said converter is arranged for a Direct Current, DC, input voltage.

In an example, said converter is arranged for a plurality of different configurations, providing 3^{k} conversion ratios, k being a number of sets of switching means comprising said switching means of each of said stage and an input voltage, an output voltage, and a ground, for converting said input voltage to said output voltage.

In an example, said converter is arranged for a plurality of different configurations providing a step-up conversion ratio of a maximum of 1:2\hat{ }(k−2) and a step-down conversion ratio of a minimum of 2\hat{ }(k−2):1.

In an example, the converter further comprises an post-stage comprising an output capacitor connected in parallel with a node of said post-stage.

In an example, the converter further comprises an pre-stage comprising an input capacitor connected in parallel with a node of said pre-stage.

In an example, said converter is arranged for converting an input voltage to an output voltage in a power range between 10 μWatt and 100 mWatt, more preferably between 50 μWatt and 50 mWatt.

In an example, said converter is arranged for powering one or more of a sensor module, IoT device, USB device, or Bluetooth module.

In a second aspect, there is provided an energy harvester arrangement comprising:
an energy harvesting module for harvesting incident energy, preferably one of solar, motion or radio frequency energy and providing said harvested energy as a input voltage to
an inductor-less power converter according to any of the previous descriptions.

In an example, said arrangement further comprises:
a maximum power point tracking module.

The skilled person will appreciate that examples, features, effects and advantages of the first aspect are similarly applicable to the second aspect and the examples relating to this second aspect.

In an example of six sets of switches and four stages of switched capacitors, the following conversion ratios are attainable:

### Example 1

A list of attainable voltage conversion ratios:

16
15
14
13
12
11
10
9
8
7.5
7
6
5.5
5.333
5
4
3.75
3.667
3.5
3.25
3.2
3
2.8
2.667
2.6
2.5
2.333
2.286
2.143
2
1.875
1.778
1.75
1.667
1.625
1.6
1.556
1.5
1.455
1.444
1.4
1.375
1.364
1.333
1.25
1.231
1.222
1.2
1.167
1.154
1.143
1.125
1.111
1.1
1.091
1.083
1.077
1.071
1.067
1
0.938
0.933
0.929
0.923
0.917
0.909
0.9
0.889
0.875
0.867
0.857
0.833
0.818
0.813
0.8
0.75
0.733
0.727
0.714
0.692
0.688
0.667
0.643
0.625
0.615
0.6
0.571
0.563
0.533
0.5
0.467
0.438
0.429
0.4
0.385
0.375
0.357
0.333
0.313
0.308
0.286
0.273
0.267
0.25
0.2
0.188
0.182
0.167
0.143
0.133
0.125
0.111
0.1
0.091
0.083
0.077
0.071
0.067
0.063

The invention will now be described in more detail by means of specific embodiments, with reference to the enclosed drawings, wherein equal or like parts and/or components are designated by the same reference numerals. The invention is in no manner whatsoever limited to the embodiments disclosed.

### BRIEF DESCRIPTION OF THE DRAWINGS

The present disclosure will now be explained by means of a description of an embodiment of an inductor-less power converter in accordance to the first aspect, and an energy harvester arrangement in accordance to the second aspect, in which reference is made to the following figures, in which:

FIG. 1 shows an embodiment of a 5-phase an inductor-less power converter in accordance to the first aspect of the present disclosure.

FIG. 2 shows in more detail the 5-phase inductor-less power converter of FIG. 1.

FIG. 3A shows an embodiment of an efficient inductor-less PMIC comprising a power converter in accordance to the first aspect of the present disclosure.

FIG. 3B shows an embodiment of an energy harvester arrangement in accordance to the second aspect of the present disclosure, comprising the efficient inductor-less PMIC of FIG. 3A.

FIG. 3C shows the net battery energy change relative to the time of the energy harvester arrangement of FIG. 3B.

FIG. 4A shows another embodiment of an efficient inductor-less PMIC comprising a power converter in accordance to the first aspect of the present disclosure.

FIG. 4B shows an embodiment of an power conversion arrangement, comprising the efficient inductor-less PMIC of FIG. 4A.

### DETAILED DESCRIPTION

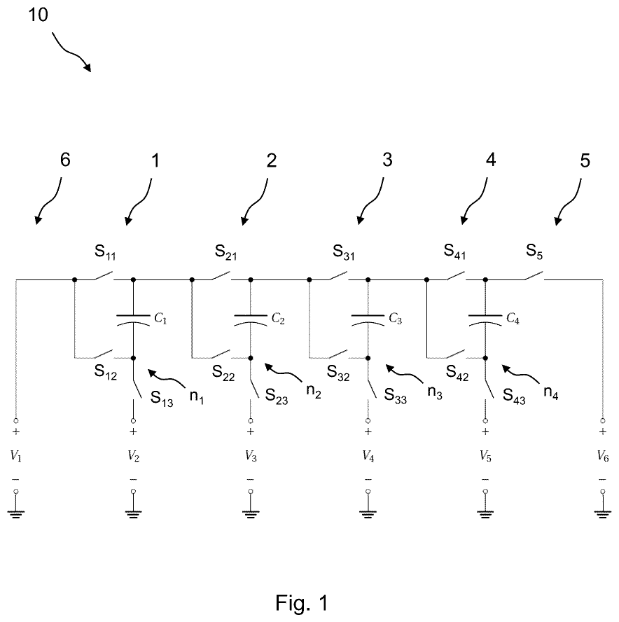

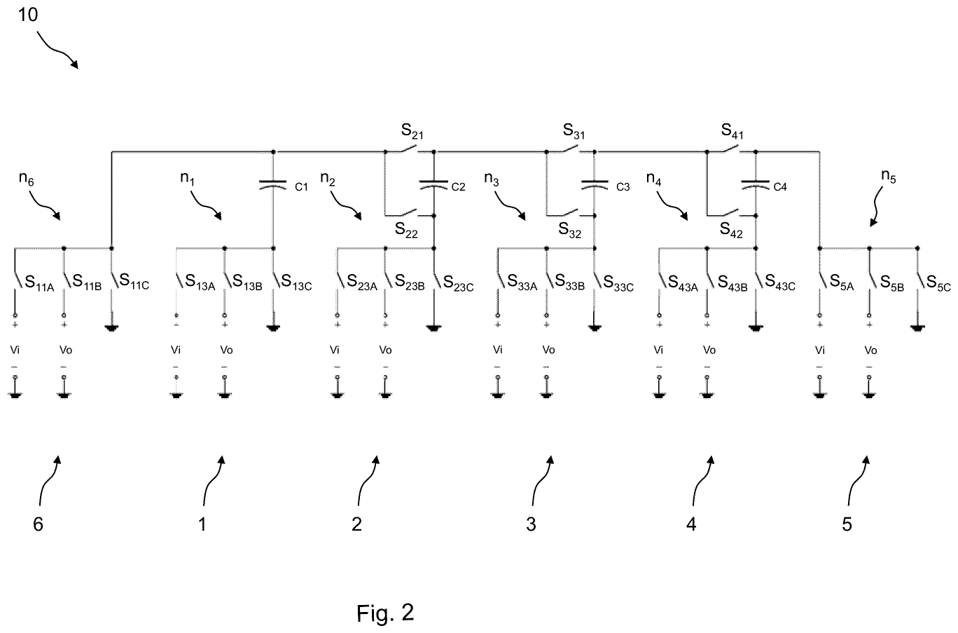

FIGS. 1 and 2 show a (k−1)-phase reconfigurable inductor-less power converter 10, with (k−1) equal to 5, for converting a DC input voltage V_{I} to a DC output voltage V_{O} at a conversion ratio M. The 5-phase reconfigurable power converter 10 is arranged for powering a sensor module, IoT device, USB device, or Bluetooth module. The converter 10 according to the present disclosure is in particular designed for extremely low power conditions and is arranged for converting the input voltage V_{I} to the DC output voltage V_{O} in a power range between 10 μWatt and 100 mWatt, more preferably between 50 μWatt and 50 mWatt.

The 5-phase reconfigurable power converter 10 comprises four stages 1, 2, 3, 4. Each stage n comprises a capacitor Cₙ, switching means Sₙ₁, Sₙ₂, Sₙ₃ and a node nₙ. Each capacitor is configured as a switched capacitor, wherein the switching means Sₙ₁, Sₙ₂, Sₙ₃ are arranged for switching the stage n and for connecting the capacitor Cₙ. The node nₙ is arranged for connecting one of an input voltage V_{I}, output voltage V_{O} or ground to the node nₙ.

The 5-phase power converter 10 furthermore comprises a pre-stage 6 and a post-stage 5. Each of the stage n, the pre-stage 6 and the post-stage 5 comprises an input voltage node V_{I}, an output voltage node V_{O} and a ground node. The switching means Sₙ₁, Sₙ₂, Sₙ₃ are arranged for connecting the respective stage 1, 2, 3, 4, 5, 6 to either the input voltage V_{I}, the output voltage V_{O} or ground. This shown in more detail in FIG. 2, wherein the switches S₁₁ and S₁₂ are replaced by individual switches S_{11A}, S_{11B}, S_{11C}, switches Sₙ₃ are replaced by individual switches S_{n3A}, S_{n3B}, S_{n3C}, where n=1 to 4, and switch S₅ is replaced by individual switches S_{5A}, S_{5B}, S_{5C}. Each switch is implemented as a single-pole-single-throw switch for switching the stage n, for connecting the capacitor Cₙ and for connecting the respective stage n, the pre-stage 6 and/or the post-stage 5 to one of the input voltage V_{I} node, output voltage V_{O} node and ground node.

The 5-phase power converter 10 is arranged for bi-directional power conversion and comprises a controller 20 for controlling the switching means Sₙ₁, Sₙ₂, Sₙ₃ of each of the n stages, the pre-stage 6 and the post-stage 5, wherein the controller is arranged for at least (k−1) phases, in this embodiment (k−1) is equal to 5. The table below shows the position of the switching means Sₙ₁, Sₙ₂, Sₙ₃, and S₅ per phase, referring to FIG. 1.

| | switch | | | | | | | | |
|---|---|---|---|---|---|---|---|---|---|
| phase | S₁₁ S₁₂ S₁₃ | | S₂₁ S₂₂ S₂₃ | | S₃₁ S₃₂ S₃₃ | | S₄₁ S₄₂ S₄₃ | | S₅ |
| 1 | 1 | 0 | 0 | 0 | 0 | 0 | 0 | 0 | 0 |
| 2 | 0 | 1 | 1 | 0 | 0 | 0 | 0 | 0 | 0 |
| 3 | 0 | 1 | 0 | 1 | 1 | 0 | 0 | 0 | 0 |
| 4 | 0 | 1 | 0 | 1 | 0 | 1 | 1 | 0 | 0 |
| 5 | 0 | 1 | 0 | 1 | 0 | 1 | 0 | 1 | 1 |

The 5-phase power converter 10 is arranged for obtaining a plurality of different configurations, providing 3^{k}, which for this embodiment is equal to 729, of different configurations for converting the DC input voltage V_{I} to the DC output voltage V_{O}, where k is a number of sets of switching means {S_{11A}, S_{11B}, S_{11C}}, {S_{n3A}, S_{n3B}, S_{n3C}}, where n=1 to 4, and {S_{5A}, S_{5B}, S_{5C}} of the pre-stage 6, stage n, and post-stage 5 respectively. Each set of the sets of switching means is arranged for connecting the respective stage n, the pre-stage 6 and/or the post-stage 5 to the input voltage V_{I} node, the output voltage V_{O} node or the ground node, for converting said input voltage V_{I} to said output voltage V_{O}.

729 different configurations can be made by switching the sets of switching means, of which 178 unique voltage conversion ratios M are obtained, of which 119 are positive, providing a step-up conversion ratio M of a maximum of 1:2\hat{ }(k−2), and a step-down conversion ratio of a minimum of 2\hat{ }(k−2):1. The conversion ratio M is described as:

$$M = \frac{\vec{a} \cdot [ \begin{matrix}16 \\ - 8 \\ - 4 \\ - 2 \\ - 1 \\ - 1\end{matrix} ]}{\vec{b} \cdot [ \begin{matrix}- 16 \\ 8 \\ 4 \\ 2 \\ 1 \\ 1\end{matrix} ]}$$

where \vec{a}=[a₁ a₂ a₃ a₄ a₅ a₆], where aₙ=1 when node nₙ is connected to the input voltage V_{I} and aₙ=0 otherwise, and \vec{b}=[b₁ b₂ b₃ b₄ b₅ b₆], where bₙ=1 when node nₙ is connected to the output voltage V_{O} and bₙ=0 otherwise. In case aₙ=0 and bₙ=0, node nₙ is being connected to ground.

Conversation ratio M=16 is for instance obtained by \vec{a}=[1 0 0 0 0 0] and \vec{b}=[0 0 0 0 0 1], conversation ratio M=13/5 is for instance obtained by \vec{a}=[1 0 0 1 1 0] and \vec{b}=[0 0 1 0 0 1], and conversation ratio M=1/5 is for instance obtained by \vec{a}=[0 0 1 0 1 0] and \vec{b}=[1 0 0 0 0 1].

The 5-phase reconfigurable power converter 10 is designed for application in an efficient inductor-less Power Management Integrated Circuit, PMIC, module.

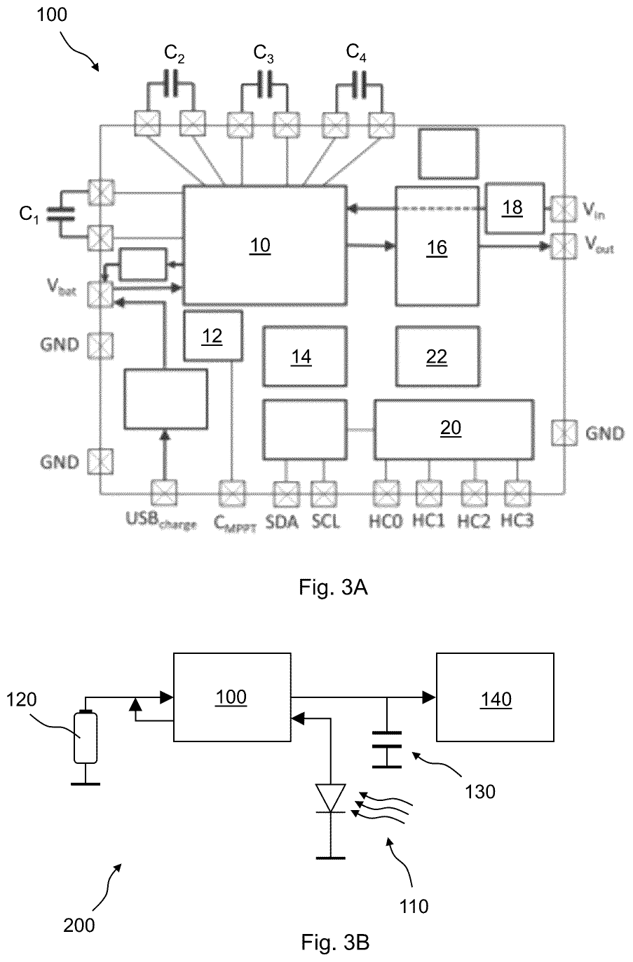

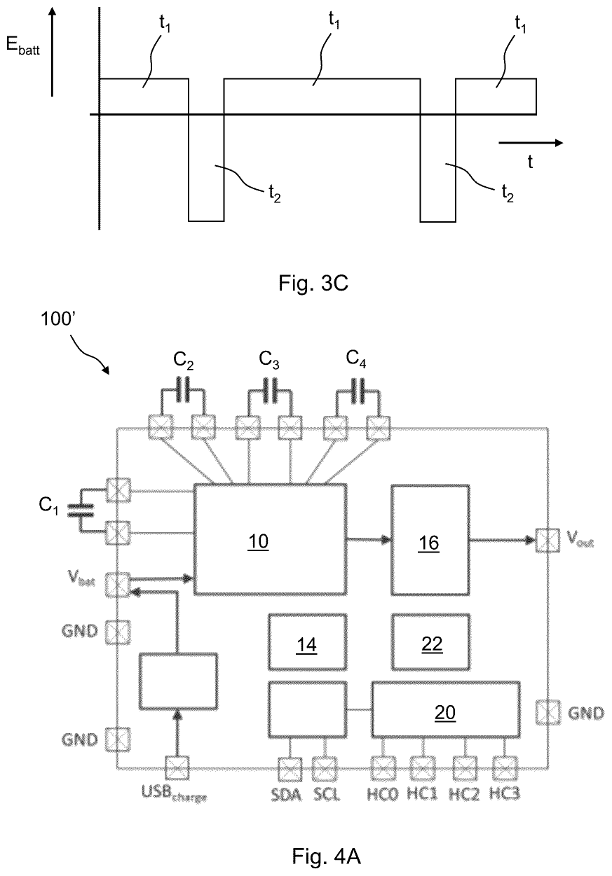

A first embodiment of an efficient inductor-less PMIC module 100 is shown in FIG. 3A. The efficient inductor-less PMIC module 100 has cold start capability and comprises, embedded therein, the 5-phase reconfigurable power converter 10, an Maximum Power Point Tracker, MPPT, 12, a Power On Reset, POR, 14, a post regulator 16, a bypass regulator 18, the controller 20, and references oscillators 22. The capacitors Cₙ are connected external to the PMIC module 100. The inductor-less PMIC module 100 is arranged for harvesting incident energy, such as solar, motion or radio frequency energy.

The efficient inductor-less PMIC module 100, comprising the power converter 10, is applicated in the energy harvesting arrangement 200 as shown in FIG. 3B, wherein the PMIC module 100 is arranged for harvesting incident energy, such as radio frequency energy 110. The harvested energy is provided as an input voltage to the energy harvesting arrangement 200. The energy harvesting arrangement 200 furthermore comprises a battery 120, a buffer capacitor 130 and a sensor module 140.

Referring to FIG. 3C, which shows the net battery energy change E_{batt} relative to the time t, the harvested energy is transferred, during time periods t₁, via the PMIC module 100, to the battery 120 for charging the battery 120. During time periods t₁, the sensor module 140 is inactive. During time periods t₂, when the sensor module 140 is active, the battery 120 is discharged by the sensor module 140 and energy from the battery is transferred, via the PMIC module 100 and the buffer capacitor 130, to the sensor module 140.

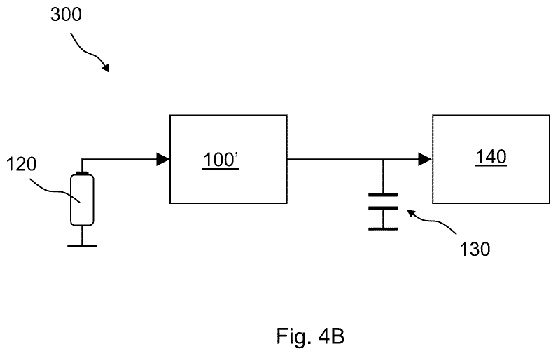

A second embodiment of an efficient inductor-less PMIC module 100′ is shown in FIG. 4A. The efficient inductor-less PMIC module 100′ has cold start capability and comprises, embedded therein, the 5-phase reconfigurable power converter 10, a Power On Reset, POR, 14, a post regulator 16, the controller 20, and references oscillators 22. The capacitors Cₙ are connected external to the PMIC module 100′.

The efficient inductor-less PMIC module 100′, comprising the power converter 10, is applicated in the power conversion arrangement 300 as shown in FIG. 4B, wherein the PMIC module 100′ is arranged for converting and transferring an input voltage from a battery 120, via the PMIC module 100′ and a buffer capacitor 130, to a sensor module 140.

Based on the above description, a skilled person may provide modifications and additions to the method and arrangement disclosed, which modifications and additions are all comprised by the scope of the appended claims.

What is claimed is:

1. An inductor-less power converter for converting an input voltage to an output voltage at a conversion ratio, comprising:
a plurality of stages, each stage comprising a capacitor, switching means and a node, the capacitor being configured as a switched capacitor, wherein the switching means is configured for switching the stage and connecting the capacitor, and the node is configured to connect one of an input voltage, output voltage or ground to the node;
wherein the inductor-less power converter is a reconfigurable power converter comprising at least four stages;
wherein each of the stages comprises an input voltage node, an output voltage node and a ground node;
wherein the switching means is configured to connect a respective stage to one of the input voltage node, output voltage node and ground node for obtaining a plurality of different configurations, and providing a plurality of different conversion ratios for converting the input voltage to the output voltage; and
a pre-stage and a post-stage, each of the pre-stage and post-stage comprising switching means configured to connect one of an input voltage node, output voltage node and ground node, wherein the switching means of the pre-stage replaces the switching means for a first stage of the plurality of stages.

2. The inductor-less power converter according to claim 1, wherein the switching means of each of the stages comprise a single-pole-single-throw switch to connect the respective stage to one of the input voltage node, output voltage node and ground node.

3. The inductor-less power converter according to claim 1, further comprising a controller configured to control the switching means of each of the stages, wherein the controller is arranged for at least (k−1) phases.

4. The inductor-less power converter according to claim 1, wherein the power converter is arranged for bi-directional power conversion.

5. The inductor-less power converter according to claim 1, wherein the converter is arranged for a Direct Current (DC) input voltage.

6. The inductor-less power converter according to claim 1, wherein the converter is arranged for a plurality of different configurations, providing 3k conversion ratios, wherein k is a number of sets of switching means comprising the switching means of each of the stage and an input voltage, an output voltage, and a ground, for converting the input voltage to the output voltage.

7. The inductor-less power converter according to claim 1, further comprising a post-stage comprising an output capacitor connected in parallel with a node of the post-stage.

8. The inductor-less power converter according to claim 1, further comprising a pre-stage that comprises an input capacitor connected in parallel with a node of the pre-stage.

9. The inductor-less power converter according to claim 1, wherein the converter is configured to convert an input voltage to an output voltage in a power range between 10 μWatt and 100 mWatt.

10. The inductor-less power converter according to claim 1, wherein the converter is arranged for powering at least one device or module selected from the group consisting of: a sensor module, a IoT device, a USB device, and a Bluetooth module.

11. The inductor-less power converter according to claim 2, further comprising a controller configured to control the switching means of each of the stages, wherein the controller is arranged for at least (k−1) phases.

12. The inductor-less power converter according to claim 2, wherein the power converter is arranged for bi-directional power conversion.

13. The inductor-less power converter according to claim 2, wherein the converter is arranged for a Direct Current (DC) input voltage.

14. The inductor-less power converter according to claim 3, wherein the converter is arranged for a plurality of different configurations, providing 3k conversion ratios, wherein k is a number of sets of switching means comprising the switching means of each of the stage and an input voltage, an output voltage, and a ground, for converting the input voltage to the output voltage.

15. The inductor-less power converter according to claim 3, further comprising a post-stage comprising an output capacitor connected in parallel with a node of the post-stage.

16. The inductor-less power converter according to claim 6, wherein the converter is arranged for a plurality of different configurations providing a step-up conversion ratio of a maximum of 1:2\hat{ }(k−2) and a step-down conversion ratio of a minimum of 2\hat{ }(k−2):1.

17. An energy harvester arrangement comprising:
an energy harvesting module for harvesting incident energy, and providing the harvested energy as an input voltage to the energy harvester arrangement;
an inductor-less power converter according to claim 1.

18. The energy harvester arrangement according to claim 17, wherein the arrangement further comprises:
a maximum power point tracking module.
